(19) United States
(12) Patent Application Publication
(10) Pub. No.: US 2015/0070267 A1
(43) Pub. Date: Mar. 12, 2015

(54) MISRECOGNITION REDUCING MOTION RECOGNITION APPARATUS AND METHOD

(71) Applicant: Hyundai Motor Company, Seoul (KR)

(72) Inventor: Sung Un Kim, Yongin (KR)

(73) Assignee: Hyundai Motor Company, Seoul (KR)

(21) Appl. No.: 14/143,515

(22) Filed: Dec. 30, 2013

(30) Foreign Application Priority Data
Sep. 6, 2013 (KR) 10-2013-0107488

(51) Int. Cl. G06K 9/00

(52) U.S. Cl. CPC G06K 9/00375; G06K 9/00335
USPC 345/156

(57) ABSTRACT

A misrecognition reducing motion recognition apparatus and method are provided. A photographing unit of the apparatus photographs an image within a vehicle and a controller detects a thermal change within a set region. The controller operates a corresponding device within the vehicle by recognizing a gesture motion from the photographed image in response to determining that the gesture motion exists by the detection of the thermal change.

### CROSS-REFERENCE TO RELATED APPLICATION

This application claims priority to and the benefit of Korean Patent Application No. 10-2013-0107488 filed in the Korean Intellectual Property Office on Sep. 6, 2013, the entire contents of which are incorporated herein by reference.

### BACKGROUND

(a) Field of the Invention

The present invention relates to a misrecognition reducing motion recognition apparatus and method.

(b) Description of the Related Art

In presently built vehicles, various mounted devices are included for user convenience. For example, convenient equipment, such as electronic devices including an audio system, a navigation system, a portable phone hands free system, or an air conditioner, are mounted within the vehicle. However, a driver is required to directly contact the various devices within the vehicle to operate the devices, which may interfere with safe driving. Accordingly, in the related art, a hand motion of a driver is captured by an imaging device, and a gesture pose or motion by the hand motion is recognized using an image processing algorithm to operate various devices. However, in the motion recognition apparatus in the related art, the motion may be misrecognized due to an external environment, such as solar light or lighting and thus, verification of reliability for the motion recognition is required.

The above information disclosed in this section is merely for enhancement of understanding of the background of the invention and therefore it may contain information that does not form the prior art that is already known in this country to a person of ordinary skill in the art.

### SUMMARY

The present invention provides a misrecognition reducing motion recognition apparatus and method, which may remove (e.g., reduce) misrecognition in motion recognition to improve reliability of the motion recognition.

An exemplary embodiment of the present invention provides a motion recognition apparatus that may include a plurality of units executed by a gesture-based controller. The plurality of units may include: a photographing unit configured to photograph an image within a vehicle; a thermal change detection unit configured to detect a thermal change within a set region; wherein the gesture-based controller may be configured to operate a corresponding device within the vehicle by recognizing a gesture motion from the photographed image in response to determining that the gesture motion exists by the detection of the thermal change by the thermal change detection unit.

In particular, the gesture-based controller may include: a motion existence/nonexistence determination unit configured to determine existence/nonexistence of the motion through existence/nonexistence of the thermal change detected by the thermal change detection unit; an image processor configured to photograph an image by operating the photographing unit, and recognize the gesture motion from the photographed image when the motion existence/nonexistence determination unit determines that the motion exists; and a device controller configured to operate a device within the vehicle based on the gesture motion recognized by the image processor.

Further, the image processor may include: an image extracting unit configured to extract an image of a hand or a finger from the image photographed by the photographing unit; a gesture database (DB) configured to store a plurality of elements of gesture information to operate the device within the vehicle; and a gesture recognition unit configured to recognize a gesture motion that corresponds to the image of the hand or the finger extracted by the image extracting unit using the gesture information stored in the gesture DB.

Additionally, the thermal change detection unit may use a pyro-electric sensor configured to detect an external thermal change and output a signal that corresponds to the detected thermal change. The pyro-electric sensor may be configured to set a region in which the thermal change is detected by adjusting a view angle of a lens.

Another exemplary embodiment of the present invention provides a method of recognizing a motion of a driver by a motion recognition apparatus installed within a vehicle, the method may include: determining, by a controller, existence/nonexistence of a motion by detection of a thermal change within a set region; photographing, by a controller, an image in response to determining that the motion exists within the set region; recognizing, by the controller, a gesture motion from the photographed image; and operating, by the controller, a device within the vehicle based on the recognized gesture motion. In particular, in the determination of the existence/nonexistence of the motion, the region in which the thermal change is detected may be set by adjusting a view angle of the lens.

Yet another exemplary embodiment of the present invention provides a motion recognition apparatus that may include a plurality of units executed by a gesture-based controller. The plurality of units may include: a photographing unit configured to photograph an image within a vehicle; and a thermal change detection unit configured to detect a thermal change within a set region; wherein the gesture-based controller may be configured to store an image photographed by the photographing unit, and operate a corresponding device within the vehicle by recognizing a gesture motion from the stored image in response to determining that the gesture motion exists by the detection of the thermal change by the thermal change detection unit.

In particular, the gesture-based controller may include: an image storing unit configured to store the image photographed by the photographing unit; a motion existence/nonexistence determination unit configured to determine existence/nonexistence of the motion through existence/nonexistence of the thermal change detected by the thermal change detection unit; an image processor configured to recognize the gesture motion from the image stored in the image storing unit when the motion existence/nonexistence determination unit determines that the motion exists; and a device controller configured to operate a device within the vehicle based on the gesture motion recognized by the image processor. The image processor may be configured to recognize the gesture motion using the image photographed during a predetermined time section, in which the motion existence/nonexistence determination unit determines that the motion exists, and stored in the image storing unit among the images stored in the image storing unit.

According to the exemplary embodiments of the present invention, existence/nonexistence of the motion may be detected through the thermal change, and the image may be photographed when the motion is detected, and thus possible misrecognition of the motion due to an external environment may be reduced, thereby improving reliability for the motion recognition. Further, existence/nonexistence of the gesture motion may be detected using a low power sensor, and the image may be photographed using the imaging device when the motion is detected, to decrease power of the imaging device. A gesture may thus be specifically recognized in a predetermined region by adjusting a view angle of the lens of a pyro-electric sensor, to remove (e.g., reduce) misrecognition in a region other than the gesture region.

### BRIEF DESCRIPTION OF THE DRAWINGS

FIG. 1 is an exemplary drawing illustrating a motion misrecognition concept by external light in a general motion recognition apparatus according to the related art;

FIG. 2 is an exemplary diagram illustrating a schematic configuration of a misrecognition reducing motion recognition apparatus according to an exemplary embodiment of the present invention;

FIG. 3 is an exemplary block diagram illustrating a particular configuration of a gesture-based controller illustrated in FIG. 2 according to an exemplary embodiment of the present invention;

FIG. 4 is an exemplary block diagram illustrating a particular configuration of an image processor illustrated in FIG. 3 according to an exemplary embodiment of the present invention;

FIG. 5 is an exemplary flowchart of a misrecognition reducing motion recognition method according to an exemplary embodiment of the present invention; and

FIG. 6 is an exemplary drawing illustrating a motion recognition concept of the motion recognition apparatus according to the exemplary embodiment of the present invention.

Description of symbols

| | |
|---|---|
| 10: Motion recognition apparatus | 100: Photographing unit |
| 200: Thermal change detection unit | |
| 300: Gesture-based controller | 400: Device within vehicle |

| 310: Motion existence/nonexistence determination unit | |
|---|---|
| 320: Image processor | 330: Device controller |

| | |
|---|---|
| 321: Image extracting unit | 322: Gesture database |
| 323: Gesture recognition unit | |

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In the following detailed description, exemplary embodiments of the present invention have been shown and described, simply by way of illustration. As those skilled in the art would realize, the described exemplary embodiments may be modified in various different ways, all without departing from the spirit or scope of the present invention. Accordingly, the drawings and description are to be regarded as illustrative in nature and not restrictive. Like reference numerals designate like elements throughout the specification.

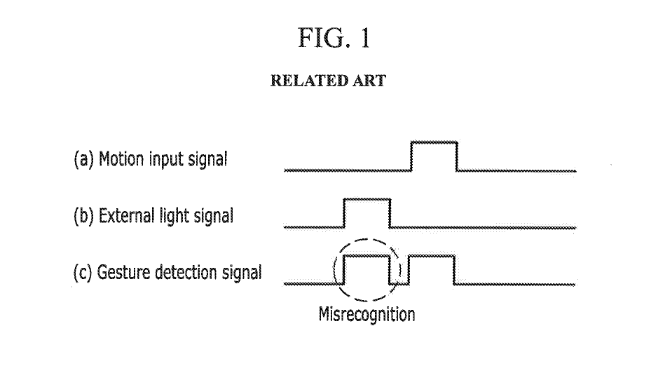

FIG. 1 is an exemplary drawing illustrating a motion misrecognition concept by external light in a general motion recognition apparatus according to the related art.

Referring to FIG. 1, when a motion input signal, which is input by a driver, is input as illustrated in graph (a) for period “a”, but an external light signal by a change in an external environment due to solar light or lighting as illustrated in graph (b) is input for period “b” before the input of the motion input signal, a motion recognition apparatus in the related art is configured to determine the external light signal and the motion input signal, as motion input, and outputs two gesture detection signals corresponding “a” and “b” as illustrated in graph (c), causing the motion to be misrecognized as if the two gesture motions are input due to the external light even though one gesture motion is input. In graph (c), the detection signal as indicated by a dotted line represents the misrecognized gesture motion detection signal.

Hereinafter, a misrecognition reducing motion recognition apparatus according to an exemplary embodiment of the present invention will be described.

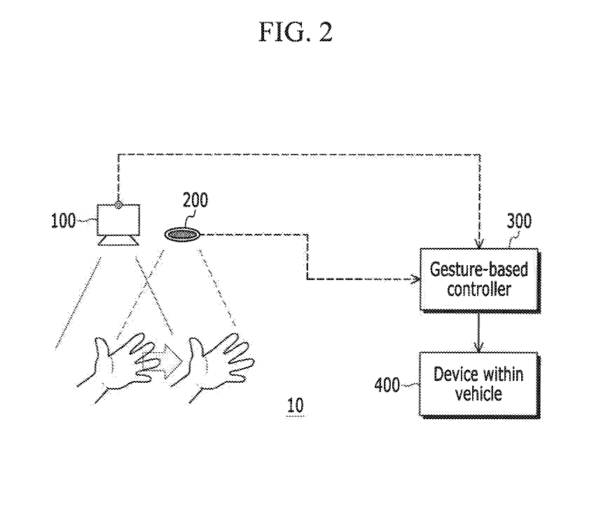

FIG. 2 is an exemplary diagram illustrating a schematic configuration of a misrecognition reducing motion recognition apparatus according to an exemplary embodiment of the present invention. As illustrated in FIG. 2, a misrecognition reducing motion recognition apparatus 10 may include a plurality of units executed by a gesture-based controller 300. The plurality of units may include a photographing unit 100 and a thermal change detection unit 200.

The photographing unit 100 may be disposed within a vehicle and may be configured to photograph an image of a driver within the vehicle. The thermal change detection unit 200 may be configured to detect an external thermal change and output a signal that corresponds to the detected thermal change. A pyro-electric sensor may be used as the thermal change detection unit 200 and may be configured to detect an external thermal change of a human body, an object, and the like, and output a signal that corresponds to the external thermal change.

Further, the thermal change detection unit 200 may further include a lens that may be configured to set a region in which the external thermal change may be detected. Accordingly, the thermal change detection unit 200 may be configured to detect a thermal change in a region set through an adjustment of a view angle of the lens, for example, a region of the driver. Accordingly, misrecognition due to an external change may be reduced in a region other than the region set by the adjustment of the view angle of the lens.

The gesture-based controller 300 may be configured to recognize a gesture motion from the photographed image photographed and may be configured to operate a device 400 within the vehicle, and when the thermal change is detected by the thermal change detection unit 200, the gesture-based controller 300 may be configured to operate the photographing unit 100 to photograph an image. In other words, in response to determining that the image photographed by the photographing unit 100 includes a motion by a gesture of the driver, the gesture-based controller 300 may be configured to operate the photographing unit 100 to photograph an image, and recognize the gesture in the photographed image.

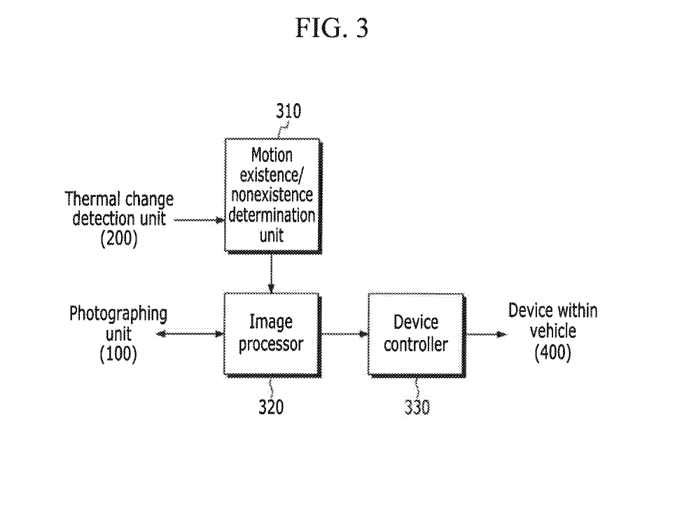

FIG. 3 is an exemplary block diagram illustrating a particular configuration of the gesture-based controller 300 illustrated in FIG. 2. As illustrated in FIG. 3, the gesture-based controller 300 may include a motion existence/nonexistence determination unit 310, an image processor 320, and a device controller 330.

The motion existence/nonexistence determination unit 310 may be configured to determine existence and nonexistence of the motion using the thermal change signal transmitted from the thermal change detection unit 200, and in response to determining that the motion exists, the motion existence/nonexistence determination unit 310 may be configured to instruct the photographing unit 100 to photograph the image, and simultaneously transmit a corresponding message regarding the existence of the motion to the image processor 320. When the message that the motion exists is transmitted from the motion existence/nonexistence determination unit 310, the image processor 320 may be configured to recognize the gesture of the driver from the image photographed by the photographing unit 100. When the gesture of the driver is recognized by the image processor 320, the device controller 330 may be configured to operate the device 400 within the vehicle based on the gesture.

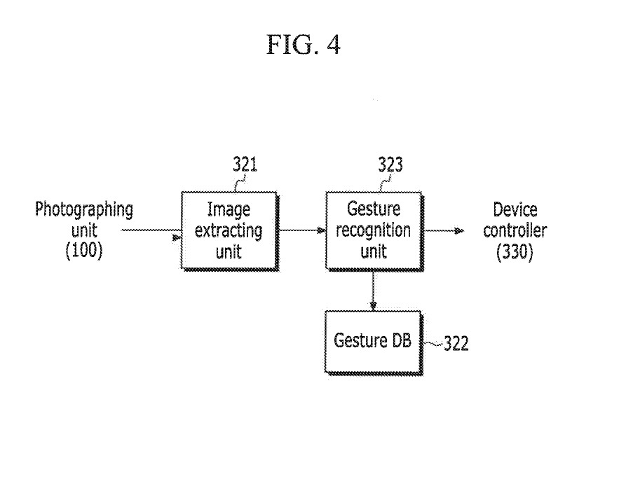

FIG. 4 is an exemplary block diagram illustrating a particular configuration of the image processor 320 illustrated in FIG. 3. As illustrated in FIG. 4, the image processor 320 may include an image extracting unit 321, a gesture database (DB) 322, and a gesture recognition unit 323, all executed by the gesture-based controller 300.

The image extracting unit 321 may be configured to extract an image of a hand or a finger of the driver (e.g., extract a detailed image) from the image photographed by the photographing unit 100. The gesture DB 322 may be configured to store information regarding various gestures that operate the device 400 within the vehicle. The information regarding the gesture is already well known and thus a detailed description thereof will be omitted. The gesture recognition unit 323 may be configured to recognize the gesture by an operation of the hand or the finger of the driver (e.g., or by an object) using the image of the hand or the finger extracted by the image extracting unit 321 and the gesture DB 322, and transmit the recognized gesture to the device controller 330.

Hereinafter, a misrecognition reducing motion recognition method according to an exemplary embodiment of the present invention will be described.

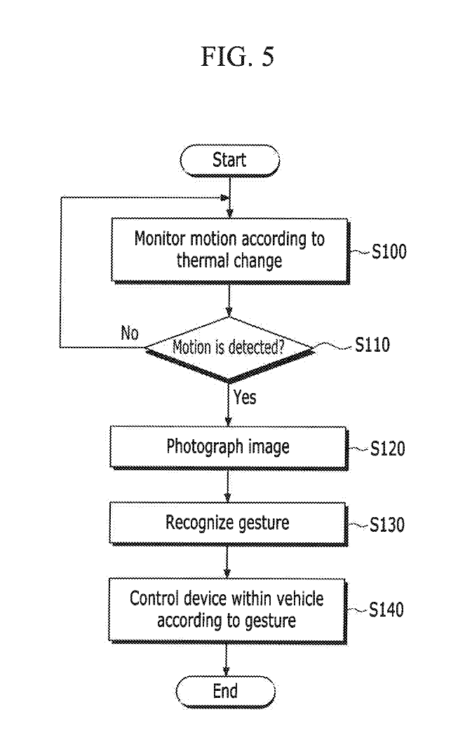

FIG. 5 is an exemplary flowchart of a misrecognition reducing motion recognition method according to an exemplary embodiment of the present invention. Referring to FIG. 5, first, the thermal change detection unit 200 may be configured to detect a thermal change in a region which may be set by the lens to detect a motion, that is, a movement of a hand or a finger and transmit gesture input to the gesture-based controller 300 (S100).

The gesture-based controller 300 may be configured to determine whether the motion is detected by the thermal change via the detection signal transmitted from the thermal change detection unit 200 (S110), and when the motion is detected, the gesture-based controller 300 may be configured to operate the photographing unit 100 to photograph an image (S120). Then, the gesture-based controller 300 may be configured to recognize the gesture from the photographed image (S130), and operate the device 400 within the vehicle based on the recognized gesture (S140). When the motion is not detected by the thermal change in step S110, steps S100 and S110 may be repeatedly performed until the motion is detected by the thermal change.

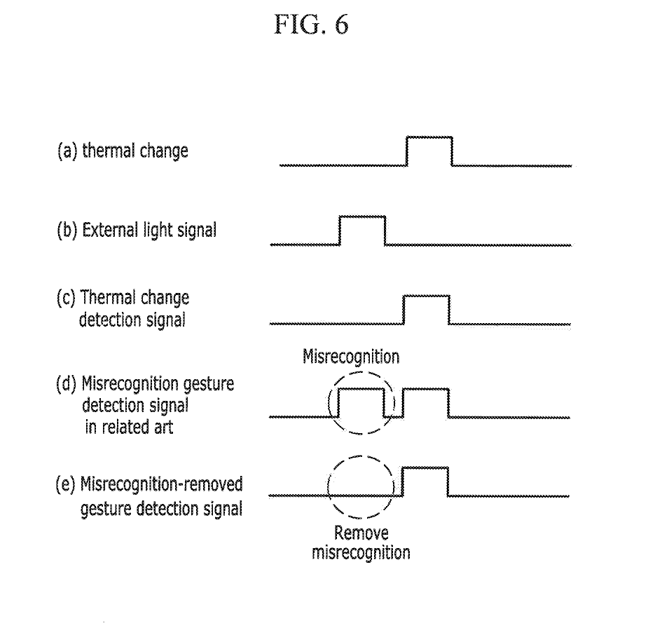

FIG. 6 is an exemplary drawing illustrating a motion recognition concept of the motion recognition apparatus according to the exemplary embodiment of the present invention.

Referring to FIG. 6, when a motion input signal, which is input by a driver, is input as illustrated in graph (a) for period “a”, and an external light signal by a change in an external environment due to solar light or lighting as illustrated in graph (b) is input for period “b” before the input of the motion input signal, input of the driver motion for period “a” may be detected by the thermal change detection unit 200 and a thermal change detection signal may be generated for period “c” as illustrated in graph (c), and the photographing unit 100 may be configured to photograph the image by the thermal change detection signal, to detect one gesture motion that corresponds to about period “c”, and the signal that corresponds to the detected gesture motion may be output as illustrated in graph (e).

Accordingly, the signal recognized as the gesture motion even in period “b” due to the misrecognition in the related art as illustrated in graph (d) may not be misrecognized in the motion recognition apparatus 100 according to the exemplary embodiment of the present invention as illustrated in graph (e). As can be seen in graph (e), a circle portion indicated with a dotted line represents that the gesture motion is detected according to the detection of the thermal change and the gesture is recognized in the exemplary embodiment of the present invention, to prevent the motion from being misrecognized.

As described above, in the exemplary embodiment of the present invention, existence and nonexistence of the motion may be detected through the thermal change, and the image may be photographed when the motion is detected, to reduce misrecognition of the motion and improve reliability for the motion recognition. Further, existence and nonexistence of the gesture motion may be detected using a low power sensor, and the image may be photographed through the imaging device when the motion is detected thus decreasing power of the imaging device.

In the meantime, when the motion is detected through a thermal change in a human body, an image is photographed using the imaging device, and the gesture may be recognized when the motion exists has been described, but the technical scope of the present invention is not limited thereto. For example, when the gesture is recognized to photograph the image using the imaging device when the motion is detected through the thermal change in the human body, a part of the gesture of the driver may not be recognized due to a time interval between the motion detection and the image photographing.

Accordingly, the photographing unit 100 may be configured to continuously photograph the image, and the gesture-based controller 300 may be configured to store the images photographed by the photographing unit 100, and directly recognize the gesture from the stored image when the thermal change is detected from the thermal change detection unit 200 and existence of the motion may be determined. The gesture-based controller 300 may further include an image storing unit 324 configured to store the image photographed by the photographing unit 100. In particular, the gesture-based controller 300 may be configured to recognize the gesture using the image photographed for a predetermined time, in which the thermal change may be detected by the thermal change detection unit 200 or a time in which the motion existence/nonexistence determination unit 310 determines that the motion exists, and stored in the image storing unit 324 among the images stored in the image storing unit 324. Accordingly, when the gesture motion of the driver is detected, the gesture may be directly recognized.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

What is claimed is:

1. A motion recognition apparatus, comprising:
a memory configured to store program instructions; and
a processor configured to execute the program instructions, the program instructions when executed configured to:
photograph an image within a vehicle;
detect a thermal change within a set region; and
operate a corresponding device within the vehicle by recognizing a gesture motion from the photographed image in response to determining that the gesture motion exists by the detection of the thermal change.

2. The motion recognition apparatus of claim 1, wherein the program instructions when executed are further configured to:
determine existence and nonexistence of the motion through existence and nonexistence of the thermal change;
recognize the gesture motion from the photographed image in response to determining existences of the motion; and
operate the device within the vehicle based on the recognized gesture motion.

3. The motion recognition apparatus of claim 2, wherein the program instructions when executed are further configured to:
extract a detailed image from the photographed image;
store a plurality of elements of gesture information in a gesture database (DB) to operate the device within the vehicle; and
recognize a gesture motion that corresponds to the detailed image using the gesture information stored in the gesture DB.

4. The motion recognition apparatus of claim 1, wherein a pyro-electric sensor is used to detect an external thermal change and is configured to output a signal that corresponds to the detected thermal change.

5. The motion recognition apparatus of claim 4, wherein the pyro-electric sensor sets a region in which the thermal change is detected by adjusting a view angle of a lens.

6. A method of recognizing a motion by a motion recognition apparatus installed within a vehicle, the method comprising:
determining, by a controller, existence and nonexistence of the motion by detection of a thermal change within a set region;
photographing, by the controller, an image in response to determining that the motion exists;
recognizing, by the controller, a gesture motion from the photographed image; and
operating, by the controller, a device within the vehicle based on the recognized gesture motion.

7. The method of claim 6, wherein a pyro-electric sensor is used to determine the existence and nonexistence of the motion.

8. The method of claim 7, wherein in the determination of the existence and nonexistence of the motion, the region in which the thermal change is detected is set by adjusting a view angle of the lens of the pyro-electric sensor.

9. A motion recognition apparatus, comprising:
a photographing unit configured to photograph an image within a vehicle;
a memory configured to store program instructions; and
a processor configured to execute the program instructions, the program instructions when executed configured to:
detect a thermal change within a set region;
store the photographed image;
operate a corresponding device within the vehicle by recognizing a gesture motion from the stored image in response to determining that a gesture motion exists by the detection of the thermal change.

10. The motion recognition apparatus of claim 9, wherein the program instructions when executed are further configured to:
determine existence and nonexistence of the motion through detected existence and nonexistence of the thermal change;
recognize the gesture motion from the stored image in response to determining existence of the motion; and
operate the device within the vehicle based on the recognized gesture motion.

11. The motion recognition apparatus of claim 10, wherein the program instructions when executed are further configured to recognize the gesture motion using the image photographed during a predetermined time section, in which the motion existence is determined, and stored among the stored images.

12. A non-transitory computer readable medium containing program instructions executed by or controller, the computer readable medium comprising:
program instructions that determine existence and nonexistence of the motion by detection of a thermal change within a set region;
program instructions that control an imaging device to photograph an image in response to determining that the motion exists;
program instructions that recognize a gesture motion from the photographed image; and
program instructions that operate a device within the vehicle based on the recognized gesture motion.

13. The non-transitory computer readable medium of claim 12, wherein a pyro-electric sensor is used to determine the existence and nonexistence of the motion.

14. The non-transitory computer readable medium of claim 13, wherein in the determination of the existence and nonexistence of the motion, the region in which the thermal change is detected is set by adjusting a view angle of the lens of the pyro-electric sensor.
